(19) United States
(12) Patent Application Publication
(10) Pub. No.: US 2025/0368030 A1
(43) Pub. Date: Dec. 4, 2025

(54) VEHICLE LID OPENING/CLOSING DEVICE

(71) Applicant: TOYODA GOSEI CO., LTD., Kiyosu-shi (JP)

(72) Inventors: Kengo SAKAI, Kiyosu-shi (JP); Kenichiro KANEKO, Kiyosu-shi (JP); Taiji HIMENO, Kiyosu-shi (JP)

(21) Appl. No.: 19/191,808

(22) Filed: Apr. 28, 2025

(30) Foreign Application Priority Data
May 29, 2024 (JP) 2024-087510

(51) Int. Cl. B60K 15/05

(52) U.S. Cl. CPC B60K 15/05; B60K 2015/0523

(57) ABSTRACT

A vehicle lid opening/closing device includes: a box body for housing therein a vehicle's replenishment port; a lid movable between a closed position and an opened position; an opening/closing mechanism for sliding the lid in a right-left direction along a vehicle body surface between the closed and opened positions; and a positioning rib structure for lifting the lid during sliding from the opened position to the closed position, and positioning the lid at the closed position. The mechanism has a main arm supported at one end portion thereof by the box body via a first rotation shaft portion and at another end portion thereof by the lid via a second rotation shaft portion, and an actuator for rotating the main arm. The second rotation shaft portion and the structure are placed within first and second predetermined distances from a horizontal position of a center of gravity of the lid.

### TECHNICAL FIELD

The present disclosure relates to a vehicle lid opening/closing device.

### BACKGROUND ART

Hitherto, a vehicle lid opening/closing device that opens and closes a replenishment port such as a charge port for replenishing a vehicle with energy, using a lid, has been known (e.g., JP2016-097757 (A) and JP2016-107680 (A)). A vehicle lid opening/closing device described in JP2016-097757 (A) or JP2016- 107680 (A) includes a box body that has a housing space for housing therein a replenishment port, a lid that is movable between a closed position at which a front-side opening of the box body is closed and an opened position at which the front-side opening is opened, and an opening/closing mechanism that slides the lid in a right-left direction including a horizontal component such as a vehicle front-rear direction along a vehicle body surface between the closed position and the opened position. The opening/closing mechanism has two upper and lower guide rails that extend in the right-left direction, and an actuator that generates a driving force to slide the lid along the two upper and lower guide rails.

In the opening/closing mechanism, when a driving force is generated by the actuator, the lid slides in the right-left direction along the two upper and lower guide rails. Therefore, in the vehicle lid opening/closing device, the lid is stably slid in the right-left direction between the closed position and the opened position by the driving of the actuator.

### SUMMARY OF INVENTION

### TECHNICAL PROBLEM

However, in the structure in which the lid is slid between the closed position and the opened position using the guide rails as described above, although stable sliding movement of the lid is achieved, there is a possibility that the guide rails will be exposed at the opened position of the lid, so that the design may be impaired.

Meanwhile, as a structure in which the lid is slid between the closed position and the opened position, a structure in which the box body and the lid are connected by an arm is conceivable. However, in this structure, usually, the lid is cantilevered, the actuator that generates a driving force is placed above the box body, one end portion of the arm is rotatably supported by the box body, and another end portion of the arm is rotatably supported by an upper portion of the lid. Thus, the lid is likely to droop downward due to gravity during sliding movement of the lid, making the sliding movement thereof (especially, sliding movement immediately before the lid reaches the closed position) unstable, so that there is a possibility that the lid cannot return to the proper closed position.

Therefore, in order to stabilize the sliding movement of the lid from the opened position to the closed position, making the arm, which supports the lid, have a robust structure is effective. However, with this structure, the weight of the vehicle lid opening/closing device increases and the efficiency of the lid opening and closing operation deteriorates, while the space required for mounting the vehicle lid opening/closing device to the vehicle body increases.

The present disclosure has been made in view of such circumstances, and an object of the present disclosure is to provide a vehicle lid opening/closing device that easily stabilizes sliding movement of a lid from an opened position to a closed position in a structure in which the lid is supported by a box body via an arm.

### SOLUTION TO PROBLEM

An aspect of the present disclosure is directed to a vehicle lid opening/closing device including: a box body mounted on a vehicle body and provided with a housing space configured to house therein a replenishment port for replenishing a vehicle with energy and a front-side opening configured to expose the replenishment port in the housing space to outside of the vehicle therethrough; a lid configured to be movable between a closed position at which the front-side opening is closed and the replenishment port is blocked and an opened position at which the front-side opening is opened and the replenishment port is exposed to the outside of the vehicle; an opening/closing mechanism configured to slide the lid in a right-left direction including a horizontal component along a vehicle body surface between the closed position and the opened position; and a positioning rib structure configured to lift the lid as the lid is slid from the opened position to the closed position by the opening/closing mechanism, and position the lid with respect to the box body at the closed position, wherein the opening/closing mechanism has a main arm rotatably supported at one end portion thereof by the box body via a first rotation shaft portion extending in an up-down direction and rotatably supported at another end portion thereof by the lid via a second rotation shaft portion extending in the up-down direction, and an actuator configured to apply a driving force to rotate the main arm, to the one end portion of the main arm, the second rotation shaft portion is placed within a first predetermined distance in a right-left direction from a horizontal position of a center of gravity of the lid, and the positioning rib structure is placed within a second predetermined distance in the right-left direction from the horizontal position of the center of gravity of the lid at the closed position of the lid.

With this configuration, the sliding movement of the lid is easily stabilized in a structure in which the lid is supported by the box body via the arm.

### BRIEF DESCRIPTION OF DRAWINGS

FIG. 1 is a perspective view of a state where a vehicle lid opening/closing device according to one embodiment of the present disclosure is mounted on a vehicle body and a lid is at a closed position, as viewed from the outside of a vehicle;

FIG. 2 is a perspective view of a state where the lid in the vehicle lid opening/closing device of the embodiment is at an opened position, as viewed from the outside of the vehicle;

FIG. 3 is an exploded view of the vehicle lid opening/closing device of the embodiment as viewed from the outside of the vehicle;

FIG. 4 is an exploded view of the vehicle lid opening/closing device of the embodiment as viewed from the inside of the vehicle;

FIG. 5 is a perspective view of a box body and an arm of an opening/closing mechanism included in the vehicle lid opening/closing device of the embodiment as viewed from the outside of the vehicle;

FIG. 6 is a perspective view of the lid and the arm of the opening/closing mechanism included in the vehicle lid opening/closing device of the embodiment as viewed from the inside of the vehicle;

FIG. 7 is a rear view of the lid and a main arm of the opening/closing mechanism included in the vehicle lid opening/closing device of the embodiment as viewed from the inside of the vehicle; and

FIG. 8 illustrates a lid lifting operation during a lid closing operation in the vehicle lid opening/closing device of the embodiment.

### DESCRIPTION OF EMBODIMENTS

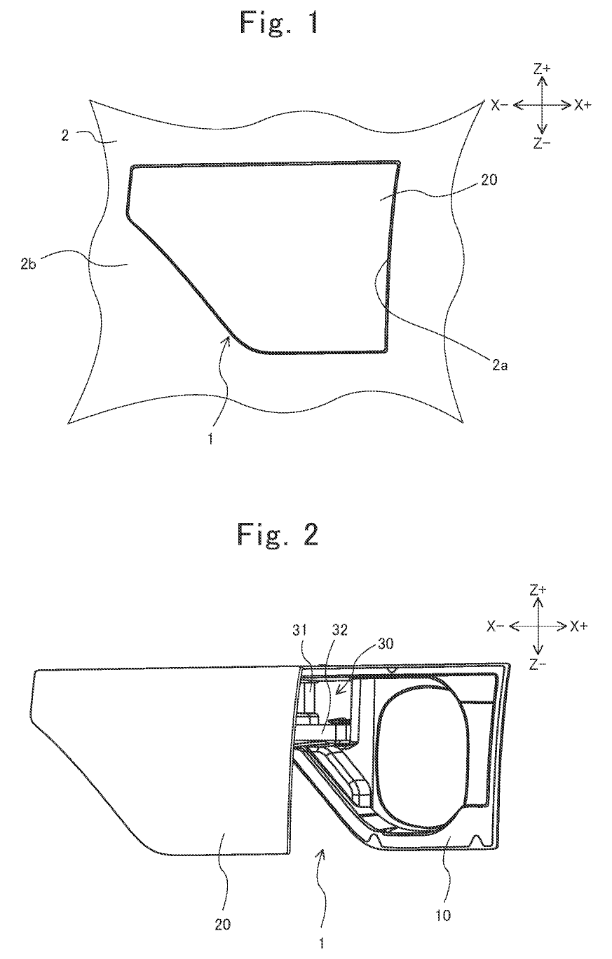

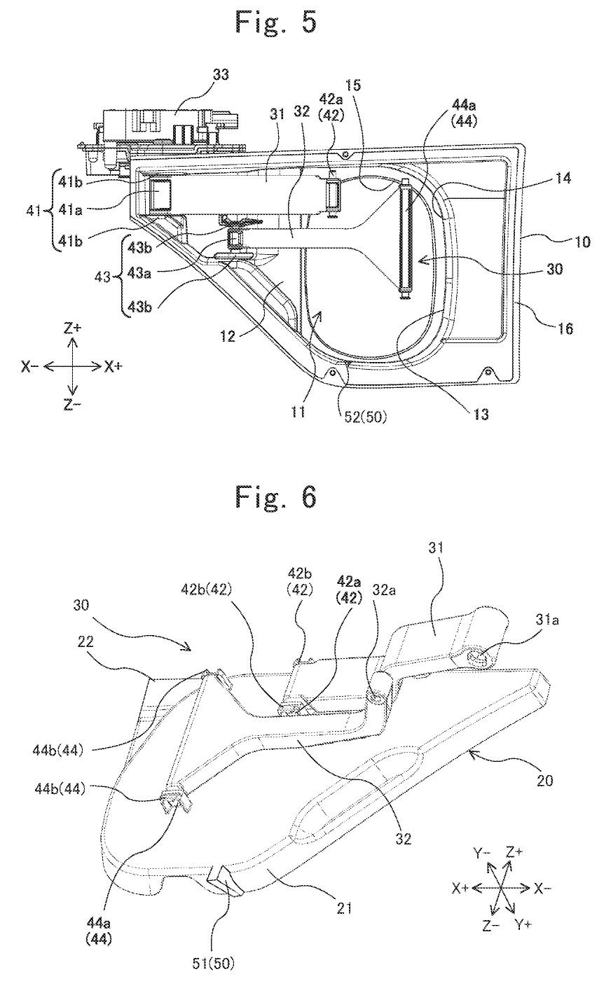

Hereinafter, a specific embodiment, etc., of a vehicle lid opening/closing device according to the present disclosure will be described with reference to FIG. 1 to FIG. 8.

A vehicle lid opening/closing device 1 of the present embodiment is a device that is mounted on a vehicle and opens and closes a replenishment port using a lid. The vehicle on which the vehicle lid opening/closing device 1 is mounted is, for example, a gasoline vehicle, a diesel vehicle, an electric vehicle, a hybrid vehicle, a fuel cell vehicle, or the like. In addition, the replenishment port to be opened and closed by the vehicle lid opening/closing device 1 is provided in a side surface, a front surface, or the like of a vehicle body 2 (see FIG. 1), and is placed in a vehicle body opening 2a (see FIG. 1) that penetrates the vehicle body 2 in an inside-outside direction (i.e., a front- back direction). The vehicle body opening 2a may be opened facing the lateral side of the vehicle or may be opened facing the front of the vehicle, the rear of the vehicle, the oblique upper side of the vehicle, or the like.

The above replenishment port is a fuel port or a charge port provided for energy replenishment such as refueling or battery charging to the vehicle. The replenishment port is provided at one end of a pipe part or an electric wire. The other end of the pipe part or the electric wire is connected to a fuel tank, a battery, or the like placed on the vehicle body far side (i.e., the vehicle body inner side). The replenishment port may be covered by a cap that is capable of being opened and closed by an operator. A refueling gun or a charging gun for energy replenishment is connectable to the replenishment port in a state where the cap is opened.

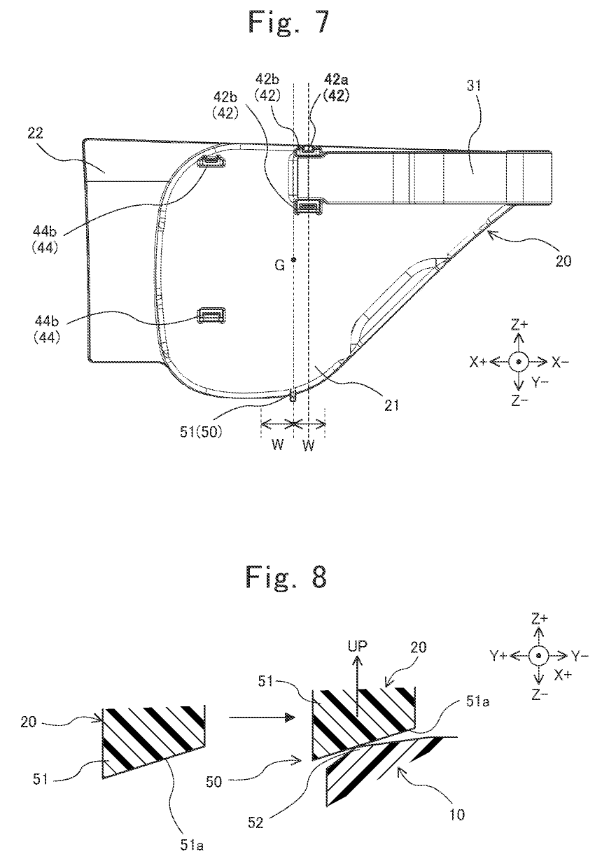

Hereinafter, as appropriate, a horizontal right-left direction when the vehicle lid opening/closing device 1 mounted on the vehicle body 2 is viewed from the outside of the vehicle is referred to as X direction, a horizontal inside-outside direction of the vehicle body 2 is referred to as Y direction, and a vertical up-down direction is referred to as Z direction. In addition, the left direction in the X direction is referred to as X- direction, the right direction in the X direction is referred to as X+ direction, the direction toward the vehicle body inside in the Y direction is referred to as Y- direction, the direction toward the vehicle body outside in the Y direction is referred to Y+ direction, the downward direction in the Z direction is referred to as Z- direction, and the upward direction in the Z direction is referred to as Z+ direction. The directions shown in FIG. 6 and FIG. 7 are directions at a closed position of a lid 20.

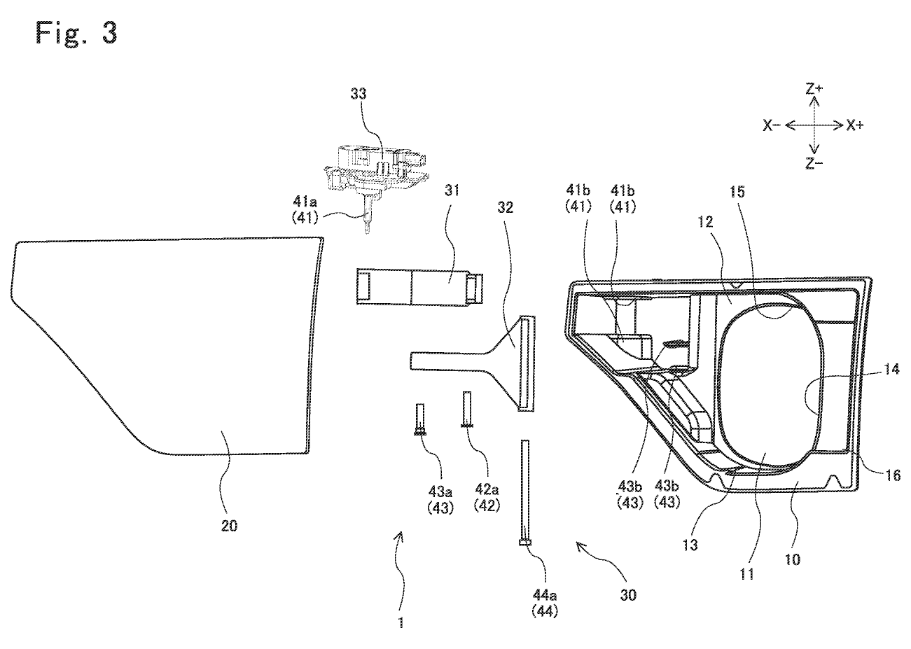

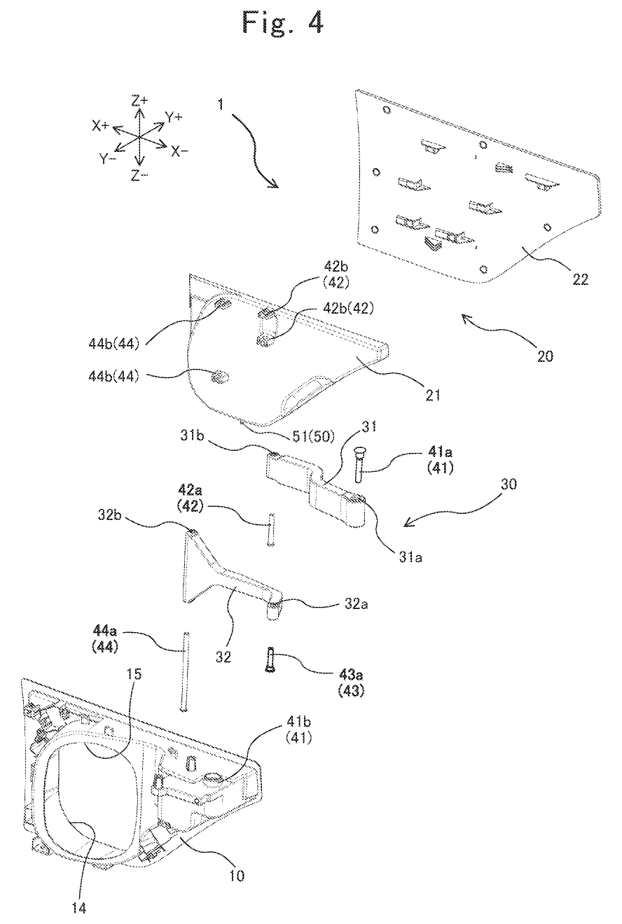

The vehicle lid opening/closing device 1 includes a box body 10, the lid 20, an opening/closing mechanism 30, and a positioning rib structure 50 as shown in FIG. 2, FIG. 3, and FIG. 4 .

The box body 10 is a box-shaped base for housing the replenishment port therein. The box body 10 is mounted on the vehicle body 2. Specifically, the box body 10 is mounted so as to be fitted into the vehicle body opening 2a provided in the vehicle body 2. As shown in FIG. 3, the box body 10 has a housing space 11, a bottom wall portion 12, a side wall portion 13, a front-side opening 14, a back-side opening 15, and a frame portion 16.

The housing space 11 is a space for housing the replenishment port therein. The housing space 11 is surrounded by the bottom wall portion 12 and the side wall portion 13. The bottom wall portion 12 is a plate wall portion having a polygonal shape (e.g., a quadrangular plate shape), a circular shape, or an elliptical shape. The bottom wall portion 12 is formed in a shape in which the upper side is long and the lower side is short (i.e., an inverted trapezoidal shape), as shown in FIG. 3, for example. The side wall portion 13 is a wall portion that is erected from an edge portion of the bottom wall portion 12 to the outside of the vehicle (Y+ direction side) so as to surround the periphery of the bottom wall portion 12. The side wall portion 13 is configured such that four plate wall portions are connected in the circumferential direction at the edge portion of the bottom wall portion 12 when the bottom wall portion 12 is formed in a quadrangular plate shape, for example. The side wall portion 13 is composed of, for example, a wall portion, of the box body 10, that extends in the right-left direction, a wall portion, of the box body 10, that extends in the vertical direction, and a wall portion, of the box body 10, that extends in an oblique direction with respect to the right-left direction.

The front-side opening 14 is an opening for exposing the replenishment port in the housing space 11 to the outside of the vehicle therethrough. The front-side opening 14 is provided on a side facing the bottom wall portion 12 across the housing space 11 in the box body 10. The front-side opening 14 is closed when the lid 20 is at the closed position, and is opened when the lid 20 is not at the closed position. When the front-side opening 14 is opened, the replenishment port in the housing space 11 is exposed to the outside of the vehicle through the front-side opening 14. The box body 10 is mounted on the vehicle body 2 such that, for example, the front-side opening 14 faces in a horizontal direction or is inclined and faces upward with respect to the horizontal direction from the vehicle body inside to the vehicle body outside.

The back-side opening 15 is an opening for exposing the replenishment port to the housing space 11 from the inside of the vehicle. The back-side opening 15 is provided in the bottom wall portion 12 of the box body 10 so as to penetrate between the inside of the vehicle and the outside of the vehicle. The back-side opening 15 is formed in the bottom wall portion 12 of the box body 10 in a circular shape, an elliptical shape, a quadrangular shape, or the like so as to match the cross-sectional shape of the replenishment port, for example.

The frame portion 16 is formed in an annular shape along a peripheral portion of the front-side opening 14. The frame portion 16 is formed in a flange shape so as to extend from the peripheral portion of the front-side opening 14 in the direction toward the frame outside. The box body 10 is positioned with respect to the vehicle body 2, for example, by the back surface of the frame portion 16 coming into contact with the front surface of the periphery of the vehicle body opening 2a of the vehicle body 2.

The lid 20 is a lid member that opens and closes the front- side opening 14 and the replenishment port. The lid 20 is movable between a closed position at which the front-side opening 14 is closed and the replenishment port is blocked and an opened position at which the front-side opening 14 is opened and the replenishment port is exposed to the outside of the vehicle (specifically, a fully-opened position). The lid 20 is movable to open and close with respect to the box body 10 by the opening/closing mechanism 30 described later operating.

The lid 20 is formed in a plate shape so as to cover the front-side opening 14 of the box body 10. The lid 20 is formed in a shape (e.g., a substantially rectangular shape) and a size that match the front-side opening 14. The lid 20 becomes flush with a vehicle body surface 2b and the frame portion 16 at the periphery of the front-side opening 14 and closes the front-side opening 14 at the closed position of the lid 20. The front surface of the lid 20 may be curved so as to match the vehicle body surface 2b.

As shown in FIG. 4, the lid 20 is composed of a lid lower portion 21 and a lid upper portion 22. The lid lower portion 21 is a plate-like component that forms the skeleton of the lid 20. The lid upper portion 22 is a plate-like component that forms the outer surface of the lid 20 and is exposed to the outside. The lid lower portion 21 is placed on the back side of the lid 20, and the lid upper portion 22 is placed on the front side of the lid 20. The lid 20 is formed by the lid lower portion 21 and the lid upper portion 22 being assembled and integrated with each other.

The lid 20 may reach the fully-opened position and be held when coming into contact with a fully open stopper and being restricted from moving, or may reach the fully-opened position and be held when the biasing force of a biasing member (not shown) reaches zero.

The opening/closing mechanism 30 is a mechanism that moves the lid 20 between the closed position and the opened position. Specifically, the opening/closing mechanism 30 slides the lid 20 in the X direction along the vehicle body surface 2b, which is the front surface of the vehicle body 2, between the closed position and the opened position. More specifically, when the lid 20 moves from the opened position to the closed position, the opening/closing mechanism 30 first slides the lid 20 in the X+ direction along the vehicle body surface 2b, and then slides the lid 20 in the Y- direction immediately before the closed position. Conversely, when the lid 20 moves from the closed position to the opened position, the opening/closing mechanism 30 first slides the lid 20 in the Y+ direction, and then slides the lid 20 in the X- direction along the vehicle body surface 2b.

The opening/closing mechanism 30 has a pair of arms 31 and 32 and an actuator 33. The opening/closing mechanism 30 may be a mechanism that causes the lid 20 to open and close using an actuator, or may be a mechanism that at least drives the lid 20 to close.

The arms 31 and 32 are arm-shaped members that extend so as to connect the box body 10 and the lid 20 and support the lid 20 such that the lid 20 is movable to open and close with respect to the box body 10. The arms 31 and 32 are housed in the housing space 11 of the box body 10 at the closed position of the lid 20. The arms 31 and 32 are configured such that the lid 20 slides along the vehicle body surface 2b relative to the box body 10 during opening or closing of the lid 20. The arms 31 and 32 constitute a pair of arms. Hereinafter, the arm 31 is referred to as main arm 31, and the arm 32 is referred to as sub-arm 32.

The main arm 31 and the sub-arm 32 move the lid 20 to open and close with respect to the box body 10 between the closed position and the opened position by rotating, and specifically, the main arm 31 and the sub-arm 32 slide the lid 20 in the horizontal X direction, while maintaining the lid 20 in a state of being parallel to the vehicle body surface 2b, during the rotation thereof. The main arm 31 and the sub-arm 32 rotate in synchronization with each other. The main arm 31 and the sub-arm 32 are each formed in an arm shape such as a straight shape, a curved shape, or a bent shape and extend in a horizontal direction in the XY plane between the box body 10 and the lid 20. The main arm 31 and the sub-arm 32 extend parallel to each other.

The main arm 31 and the sub-arm 32 extend in the X direction at least at the closed position of the lid 20. The main arm 31 is placed on the upper side, and the sub-arm 32 is placed on the lower side. That is, the sub-arm 32 is placed below the main arm 31. In addition, the main arm 31 and the sub-arm 32 are placed so as to be displaced relative to each other in the X direction.

The main arm 31 is rotatably supported at one end portion thereof by the box body 10 via a first rotation shaft portion 41 and is rotatably supported at another end portion thereof by the lid 20 via a second rotation shaft portion 42. The sub-arm 32 is rotatably supported at one end portion thereof by the box body 10 via a third rotation shaft portion 43 and is rotatably supported at another end portion thereof by the lid 20 via a fourth rotation shaft portion 44.

The main arm 31 is connected to an output shaft of the actuator 33 (specifically, a shaft body 41a of the first rotation shaft portion 41 or a shaft body connected to the shaft body 41a), and rotates when the driving force of the actuator 33 is applied thereto. The sub-arm 32 is provided separately from the main arm 31 and extends parallel to the main arm 31. The sub-arm 32 assists in the sliding movement of the lid 20 by rotating in conjunction with the rotation of the main arm 31 when the driving force is applied to the one end portion of the main arm 31 by the actuator 33.

The first rotation shaft portion 41, the second rotation shaft portion 42, the third rotation shaft portion 43, and the fourth rotation shaft portion 44 extend in the Z direction. The rotation shaft portions 41 to 44 may extend in the vertical Z direction but may extend so as to be slightly oblique with respect to the vertical Z direction. The first rotation shaft portion 41, the second rotation shaft portion 42, the third rotation shaft portion 43, and the fourth rotation shaft portion 44 have shaft bodies 41a, 42a, 43a, and 44a and bearings 41b, 42b, 43b, and 44b, respectively.

The shaft bodies 41a, 42a, 43a, and 44a are each a part that supports the lid 20 such that the lid 20 is rotatable relative to the box body 10. The bearings 41b, 42b, 43b, and 44b are each a part that has a hole or groove for supporting the corresponding shaft body 41a, 42a, 43a, or 44a. The shaft bodies 41a, 42a, 43a, and 44a are provided separately from the box body 10 and the lid 20. The shaft bodies 41a, 42a, 43a, and 44a are each formed with a circular or annular cross-section.

The shaft body 41a is inserted into an arm shaft hole 31a provided in the one end portion of the main arm 31, the shaft body 42a is inserted into an arm shaft hole 31b provided in the other end portion of the main arm 31, the shaft body 43a is inserted into an arm shaft hole 32a provided in the one end portion of the sub-arm 32, and the shaft body 44a is inserted into an arm shaft hole 32b provided in the other end portion of the sub-arm 32. The arm shaft holes 31a, 31b, 32a, and 32b are through holes. The diameters of the arm shaft holes 31a, 31b, 32a, and 32b are set correspondingly to the outer diameters of the shaft bodies 41a, 42a, 43a, and 44a to be inserted into the arm shaft holes 31a, 31b,32a, and 32b, respectively.

The bearings 41b and 43b are provided on the box body 10. The bearings 42b and 44b are provided on the lid 20. The shaft body 41a is supported by the bearing 41b, the shaft body 42a is supported by the bearing 42b, the shaft body 43a is supported by the bearing 43b, and the shaft body 44a is supported by the bearing 44b.

The main arm 31 is rotatably supported at the one end portion thereof by the box body 10 by the shaft body 41a of the first rotation shaft portion 41 being inserted into the arm shaft hole 31a and supported by the bearing 41b, and is rotatably supported at the other end portion thereof by the lid 20 by the shaft body 42a of the second rotation shaft portion 42 being inserted into the arm shaft hole 31b and supported by the bearing 42b. The sub-arm 32 is rotatably supported at the one end portion thereof by the box body 10 by the shaft body 43a of the third rotation shaft portion 43 being inserted into the arm shaft hole 32a and supported by the bearing 43b, and is rotatably supported at the other end portion thereof by the lid 20 by the shaft body 44a of the fourth rotation shaft portion 44 being inserted into the arm shaft hole 32b and supported by the bearing 44b.

The first rotation shaft portion 41 and the third rotation shaft portion 43 are placed so as to be displaced relative to each other in the right-left direction (specifically, the X direction) in the box body 10. The first rotation shaft portion 41 and the third rotation shaft portion 43 are placed at an end portion in the X- direction of the box body 10. The first rotation shaft portion 41 is placed on the X- direction side with respect to the third rotation shaft portion 43. In addition, the second rotation shaft portion 42 and the fourth rotation shaft portion 44 are placed so as to be displaced relative to each other in the right- left direction in the lid 20. The second rotation shaft portion 42 is placed at a horizontal center portion (described in detail later) of the lid 20. The fourth rotation shaft portion 44 is placed on the horizontally outer side (specifically, the X+ direction side at the time of lid closing) with respect to the second rotation shaft portion 42 in the lid 20. The main arm 31 and the sub-arm 32 are configured such that a parallelogram is maintained with the four rotation shaft portions 41 to 44 as corners when the lid 20 moves between the closed position and the opened position.

The actuator 33 is a driving source that generates a driving force to rotate the main arm 31. The actuator 33 may be an actuator that generates at least a closing driving force needed to slide the lid 20 from the opened position to the closed position. The actuator 33 is, for example, a motor. The actuator 33 applies the generated driving force to the one end portion of the main arm 31 via the first rotation shaft portion 41.

The second rotation shaft portion 42 is placed at the center portion in the right-left direction of the lid 20 as described above. Specifically, the second rotation shaft portion 42 is placed within a first predetermined distance in the right- left direction from the horizontal position of a center of gravity G (see FIG. 7) of the lid 20. That is, the horizontal position of the second rotation shaft portion 42 is within the first predetermined distance from the horizontal position of the center of gravity G (see FIG. 7) of the lid 20.

The positioning rib structure 50 is a structure that lifts the lid 20 and positions the lid 20 with respect to the box body 10 at the closed position when the lid 20 slides from the opened position to the closed position. The positioning rib structure 50 presses a part of the lid 20 against a part of the box body 10 during the closing drive of the lid 20 and lifts the entire lid 20 with respect to the box body 10.

The positioning rib structure 50 is placed within a second predetermined distance in the right-left direction from the horizontal position of the center of gravity G of the lid 20 at the closed position of the lid 20. That is, a portion, of the positioning rib structure 50, that is provided on the lid 20 is placed within the second predetermined distance in the right-left direction from the horizontal position of the center of gravity G of the lid 20. The second predetermined distance is a distance W that is the same as the above first predetermined distance.

Each of the first predetermined distance and the second predetermined distance described above is, for example, a distance of 0 mm to 40 mm or a distance that is 1/10 to 1/3 of the length in the right-left direction of the lid 20. The first predetermined distance for the placement of the second rotation shaft portion 42 and the second predetermined distance for the placement of the positioning rib structure 50 are the same as each other and set to be the distance W, but may be different from each other according to requirements.

As shown in FIG. 4 to FIG. 8, the positioning rib structure 50 has a rib 51 and a rib contact portion 52. The rib 51 is provided on the lid 20. The rib contact portion 52 is provided on the box body 10.

The rib 51 is a protrusion-like portion. The rib 51 protrudes downward from a lower portion of the lid lower portion 21 of the lid 20. The rib 51 extends in the lid 20 in a direction (specifically, the Y- direction) that coincides with a direction in which the lid 20 slides during the latter half of the sliding movement of the lid 20 from the opened position to the closed position.

The rib 51 has an inclined surface 51a. The inclined surface 51a is a surface whose height position changes in the Y- direction in which the rib 51 extends. The inclined surface 51a is inclined toward the side on which the lid 20 is lifted with respect to the movement direction of the sliding movement of the lid 20 from a starting point of contact between the rib 51 and the rib contact portion 52 accompanying the sliding movement of the lid 20 from the opened position to the closed position. That is, the inclined surface 51a faces obliquely downward in the movement direction of the sliding movement of the lid 20. The inclined surface 51a is formed such that the front side thereof is located on the upper side and the rear side thereof is located on the lower side in the movement direction of the sliding movement of the lid 20.

The rib contact portion 52 is a portion with which the rib 51 is capable of coming into contact. The rib contact portion 52 is formed on the upper surface of the side wall portion 13 constituting a lower wall, of the side wall portion 13 of the box body 10. The rib contact portion 52 may be formed in a shape that allows the lid 20 to be easily lifted as the lid 20 slides from the opened position to the closed position. For example, the rib contact portion 52 may have a function to guide the rib 51 so as to lift the lid 20 as the lid 20 slides from the opened position to the closed position.

As shown in FIG. 8, the rib contact portion 52 is provided at a corner portion at which the upper surface of the side wall portion 13 of the box body 10 intersects the side surface, of the side wall portion 13, facing in the Y+ direction, and extends linearly in the X direction. The position at which the rib 51 comes into contact with the rib contact portion 52 is on an upper portion of the inclined surface 51a of the rib 51 at the start of the contact, and then gradually moves downward as the lid 20 slides. The lid 20 is lifted with respect to the box body 10 by the rib 51 coming into contact with the rib contact portion 52 during the sliding movement of the lid 20 from the opened position to the closed position, specifically, by the position of contact of the rib 51 with the rib contact portion 52 moving downward as the sliding movement progresses.

The rib contact portion 52 may have an inclined surface that is inclined with respect to the movement direction of the sliding movement of the lid 20 and has an angle corresponding to the angle of the inclined surface 51a of the rib 51. In this case, the lid 20 slides along this inclined surface relative to the box body 10.

Hereinafter, the operation of the vehicle lid opening/closing device 1 will be described. When the lid 20 is required to open in a state where the lid 20 is at the closed position, the actuator 33 generates an opening driving force to rotate the main arm 31 to the lid-opening side. When this opening driving force is generated, the main arm 31 rotates to the lid-opening side, and the sub-arm 32 rotates to the lid-opening side in conjunction with the rotation of the main arm 31. When the arms 31 and 32 rotate to the lid-opening side, the lid 20 opens. Specifically, when the arms 31 and 32 rotate to the lid-opening side, the lid 20 first slides in the Y+ direction, and then slides in the X- direction along the vehicle body surface 2b. Accordingly, the lid 20 reaches the opened position.

When the lid 20 is required to close in a state where the lid 20 is at the opened position, the actuator 33 generates a closing driving force to rotate the main arm 31 to the lid-closing side. When this closing driving force is generated, the main arm 31 rotates to the lid-closing side, and the sub-arm 32 rotates to the lid-closing side in conjunction with the rotation of the main arm 31. When the arms 31 and 32 rotate to the lid-closing side, the lid 20 closes. Specifically, when the arms 31 and 32 rotate to the lid-closing side, the lid 20 first slides in the X+ direction along the vehicle body surface 2b, and then slides in the Y- direction. Accordingly, the lid 20 reaches the closed position.

When the lid 20 slides in the Y- direction during the sliding movement from the opened position to the closed position, the positioning rib structure 50 lifts the lid 20 and positions the lid 20 with respect to the box body 10 at the closed position of the lid 20. Specifically, first, the position at which the rib 51 of the lid 20 comes into contact with the rib contact portion 52 of the box body 10 is on the upper portion of the inclined surface 51a of the rib 51 at the start of the contact, and then moves downward as the lid 20 slides. In this case, the entire lid 20 including the rib 51 moves upward.

In other words, the lid 20 is lifted with respect to the box body 10 by the rib 51 coming into contact with the rib contact portion 52 during the sliding movement of the lid 20 from the opened position to the closed position, specifically, by the position of contact of the rib 51 with the rib contact portion 52 moving downward as the sliding movement progresses.

Therefore, even if the lid 20 is brought into a posture in which the lid 20 droops on the side opposite to the side on which the lid 20 is supported by the box body 10, by gravity due to the fact that the lid 20 is cantilevered by the box body 10 via the arms 31 and 32, the lid 20 is lifted by the positioning rib structure 50, so that the lid 20 is stably slid to the closed position, and the lid 20 is caused to accurately reach the closed position.

The second rotation shaft portion 42, which connects the main arm 31 and the lid 20, is placed at the center portion in the right-left direction of the lid 20 and is placed within the first predetermined distance W in the right-left direction from the horizontal position of the center of gravity G of the lid 20. In addition, the positioning rib structure 50 is placed within the second predetermined distance W in the right-left direction from the horizontal position of the center of gravity G of the lid 20. Each of the first predetermined distance W and the second predetermined distance W is set to, for example, a distance of 0 mm to 40 mm or a distance that is 1/10 to 1/3 of the length in the right-left direction of the lid 20.

In this structure, the lid 20 is smoothly rotated relative to the main arm 31 at the second rotation shaft portion 42 without disrupting the right-left weight balance of the lid 20, compared to a structure in which the second rotation shaft portion 42 is placed at an end portion in the right-left direction of the lid 20 so as to be significantly shifted from the center of gravity G of the lid 20. Therefore, the posture of the lid 20 is maintained in the desired posture during the sliding movement of the lid 20.

In addition, in this structure, the position in the right- left direction of the positioning rib structure 50 is closer to the position in the right-left direction of the second rotation shaft portion 42 than in a structure in which the rib 51 of the positioning rib structure 50 is placed at an end portion in the right-left direction of the lid 20 so as to be significantly shifted from the center of gravity G of the lid 20. Therefore, even if the rib 51 comes into contact with the rib contact portion 52 during the rotation of the lid 20 relative to the main arm 31 at the second rotation shaft portion 42, the closing driving force generated by the actuator 33 is efficiently transmitted to the lid 20 via the main arm 31, so that the lid posture is inhibited from deviating from the desired posture and transmission of force from the rib 51 to the rib contact portion 52 is efficiently performed.

Therefore, in the structure in which the lid 20 is supported by the box body 10 via the arms 31 and 32, the lid 20 is easily and stably slid from the opened position to the closed position, so that occurrence of a situation in which the lid 20 does not reach the closed position with a normal driving force is avoided. In addition, rotating the main arm 31 with a large force in order to cause the lid 20 to reach the closed position is not necessary, so that generation of abnormal noise when the lid 20 reaches the closed position is suppressed.

Meanwhile, in the above embodiment, the rib 51 of the positioning rib structure 50 is provided at the lower portion of the lid lower portion 21 of the lid 20 so as to protrude downward, and the rib contact portion 52 is formed on the upper surface of the side wall portion 13 constituting the lower wall, of the side wall portion 13 of the box body 10. However, the present disclosure is not limited thereto, and as long as the positioning rib structure 50 lifts the lid 20 and positions the lid 20 with respect to the box body 10 at the closed position when the lid 20 slides from the opened position to the closed position, the rib 51 may be provided at an upper portion of the lid lower portion 21 of the lid 20 so as to protrude upward and the rib contact portion 52 may be formed on the lower surface of the side wall portion 13 constituting an upper wall, of the side wall portion 13 of the box body 10.

In addition, in the above embodiment, the rib 51 is provided on the lid 20, and the rib contact portion 52 is provided on the box body 10. However, the present disclosure is not limited thereto, and the rib 51 may be provided on the box body 10, and the rib contact portion 52 may be provided on the lid 20. Alternatively, the rib 51 may be provided on the main arm 31, and the rib contact portion 52 may be provided on the box body 10.

The present disclosure is not limited to the above- described embodiment and modifications, and various changes may be made without departing from the gist of the present disclosure. In addition, the present specification discloses not only the technical concept indicated by the citation relationship between the claims as originally filed, but also the technical concept obtained by combining the matters recited in each claim as appropriate.

This application claims priority on Japanese Patent Application No. 2024-087510 filed on May 29, 2024, the entire contents of which are incorporated herein by reference.

1. A vehicle lid opening/closing device comprising:
a box body mounted on a vehicle body and provided with a housing space configured to house therein a replenishment port for replenishing a vehicle with energy and a front-side opening configured to expose the replenishment port in the housing space to outside of the vehicle therethrough;
a lid configured to be movable between a closed position at which the front-side opening is closed and the replenishment port is blocked and an opened position at which the front-side opening is opened and the replenishment port is exposed to the outside of the vehicle;
an opening/closing mechanism configured to slide the lid in a right-left direction including a horizontal component along a vehicle body surface between the closed position and the opened position; and
a positioning rib structure configured to lift the lid as the lid is slid from the opened position to the closed position by the opening/closing mechanism, and position the lid with respect to the box body at the closed position, wherein
the opening/closing mechanism has
a main arm rotatably supported at one end portion thereof by the box body via a first rotation shaft portion extending in an up-down direction and rotatably supported at another end portion thereof by the lid via a second rotation shaft portion extending in the up-down direction, and
an actuator configured to apply a driving force to rotate the main arm, to the one end portion of the main arm, the second rotation shaft portion is placed within a first predetermined distance in a right-left direction from a horizontal position of a center of gravity of the lid, and
the positioning rib structure is placed within a second predetermined distance in the right-left direction from the horizontal position of the center of gravity of the lid at the closed position of the lid.

2. The vehicle lid opening/closing device according to claim 1, wherein the first predetermined distance is a distance of 0 mm to 40 mm or a distance that is 1/10 to 1/3 of a length in the right- left direction of the lid.

3. The vehicle lid opening/closing device according to claim 1, wherein the second predetermined distance is a distance of 0 mm to 40 mm or a distance that is 1/10 to 1/3of a length in the right- left direction of the lid.

4. The vehicle lid opening/closing device according to claim 1, wherein the positioning rib structure has
a rib provided on the lid or one of the main arm and the box body, and
a rib contact portion provided on the lid or the other of the main arm and the box body, and
the lid is lifted by the rib coming into contact with the rib contact portion during sliding movement of the lid from the opened position to the closed position.

5. The vehicle lid opening/closing device according to claim 4, wherein at least one of the rib and the rib contact portion has an inclined surface that is inclined toward a side on which the lid is lifted with respect to a movement direction of sliding movement of the lid from the opened position to the closed position from a starting point of contact between the rib and the rib contact portion accompanying the sliding movement.

6. The vehicle lid opening/closing device according to claim 1, wherein the opening/closing mechanism has a sub-arm that is provided separately from the main arm, extends parallel to the main arm, is rotatably supported at one end portion thereof by the box body via a third rotation shaft portion extending in the up- down direction, is rotatably supported at another end portion thereof by the lid via a fourth rotation shaft portion extending in the up-down direction, and is configured to assist in sliding movement of the lid by rotating in conjunction with rotation of the main arm when the driving force is applied to the one end portion of the main arm by the actuator.
